(19) United States
(12) Patent Application Publication
(10) Pub. No.: US 2026/0348877 A1
(43) Pub. Date: Nov. 5, 2026

(54) SYSTEM AND METHOD FOR EXAMINING A MASK FOR EUV LITHOGRAPHY

(71) Applicant: Carl Zeiss SMT GmbH, Oberkochen (DE)

(72) Inventors: Bjoern Brauer, Magstadt (DE); Gilles Tabbone, Lournand (FR); Bjoern Froehlich, Jena (DE); Alexander Freytag, Erfurt (DE); Anka Birnstein, Dresden (DE); Michael Niebisch, Jena (DE)

(21) Appl. No.: 19/663,434

(22) Filed: Apr. 30, 2026

(30) Foreign Application Priority Data
Apr. 30, 2025 (DE) 102025116820.2

(51) Int. Cl. G01N 21/956; G01N 21/88

(52) U.S. Cl. CPC G01N 21/956; G01N 21/8851; G01N 2021/8854; G01N 2021/8887; G01N 2021/95676

(57) ABSTRACT

A system for examining a mask for EUV lithography has:an inspection system for optical inspection of a mask for identifying and/or localizing potential mask defects,a checking system for checking potential mask defects anda pre-classification system for pre-classification of the potential mask defects on the basis of images thereof, wherein the inspection system or the checking system serves as the pre-classification system.

### CROSS-REFERENCE TO RELATED APPLICATION

This application claims benefit of German patent application DE 10 2025 116 820.2, filed on Apr. 30, 2025, which is incorporated by reference herein in its entirety.

### TECHNICAL FIELD

The invention relates to a system for examining a mask for EUV lithography. The invention moreover relates to a method for inspecting a mask for EUV lithography.

### BACKGROUND

Lithography methods, for example, are used to produce microstructured or nanostructured components, for example memory chips. In this context, structures are imaged from a mask onto a wafer with the aid of a projection exposure apparatus. In order to ensure that the masks are suitable for the envisaged purpose, they are checked with the aid of an inspection system, in particular an APMI (actinic patterned mask inspection) system, prior to their use in the lithography process. In particular, provision can also be made of an inspection of the substrate provided for producing a mask, which is also referred to as mask blank. An ABI (actinic blank inspection) system can be used for this purpose.

By way of example, an ABI system is known from US 2017/0235031 A1. A system for inspecting a mask is also known from WO 2021 204 541 A1.

### SUMMARY

There is constantly a need to improve a system and a method for examining a mask for EUV lithography.

These problems are solved in particular by the features of the independent claims.

The system according to the invention and the method according to the invention are in principle independent of one another. However, the system according to the invention is suitable in particular for carrying out the method according to the invention.

One aspect of the invention consists in forming a system for examining a mask for EUV lithography with a plurality of subsystems.

The system for examining a mask for EUV lithography comprises an inspection system for optical inspection of a mask for identifying and/or localizing potential mask defects (doi, defects of interest).

In this case, an optical inspection of a mask should be understood to mean an inspection of the mask with the aid of illumination radiation. An optical inspection can comprise in particular the recording of one or more images of the mask. For this purpose, the mask can be illuminated with illumination radiation by use of an illumination optical unit. The illumination optical unit can include, e.g., a radiation source that provides the illumination radiation, and optical devices (e.g., one or more lenses, mirrors, stops, filters) to project the illumination radiation from the radiation source to the mask. An image of the mask can be generated by use of a projection optical unit, which can include one or more optical devices, e.g., one or more lenses, mirrors, stops, filters, to project the illumination radiation from the mask to one or more image sensors. Each image sensor can include, e.g., a charged coupled device (CCD) sensor or a complementary metal oxide semiconductor (CMOS) sensor. Each image sensor can have an array of independently addressable sensor elements or pixels. In particular, the image of the mask can be an aerial image or a digital image.

The identified and/or localized potential mask defects can subsequently be pre-classified and then checked.

In the pre-classification, the identified and/or localized potential mask defects are categorized in particular into at least two classes: a first class with elements wrongly identified as a potential mask defect (so-called “false positives”) and a second class with potential mask defects to be checked more closely. In principle, there can also be a third class with elements definitely identified as true mask defects. These elements likewise do not need to be checked further.

The second class obtained after the pre-classification with potential mask defects to be checked more closely can subsequently be verified by a check. In particular, the class with potential mask defects to be checked can have fewer elements than the total number of potential mask defects identified in the first step. The outlay, in particular the time outlay, for checking the potential mask defects can be reduced as a result. In this case, it may be sufficient to check just a subset of the pre-classified defects. Further details of the pre-classification are described even more thoroughly below.

The system for examining a mask for EUV lithography has a checking system for checking potential mask defects.

The system for examining a mask for EUV lithography can additionally have a pre-classification system for pre-classification of the potential mask defects. In this case, the inspection system or the checking system can serve as the pre-classification system.

The constructional outlay is thereby reduced. In addition, the method sequence during the examination of the mask can be improved as a result. In principle, the inspection system, the pre-classification system and the checking system can be physically embodied as a single system.

In accordance with a further aspect, a single examination system can have in particular an inspection mode, a pre-classification mode and a checking mode.

In the inspection mode, such an examination system can identify and/or localize potential mask defects in a first analysis step. In a further analysis step (pre-classification), confidence parameters for characterizing the certainty of the identification and/or characterizing the relevance of the mask defect for later applications can be assigned to the identified and/or localized potential mask defects. In a further analysis step, the potential mask defects, in particular a selection thereof, which can be determined in particular on the basis of the assigned confidence parameters, can be checked in the checking mode.

The localized and/or identified potential mask defects can be pre-classified and once again analyzed, in particular checked.

The mask can remain in the same system in this case. In particular, it does not need to be transferred between different systems. In particular, it is possible to obviate the need for the mask to be transferred between different subsystems between the identification and/or localization of potential mask defects in the first analysis step and the checking of potential mask defects in the third analysis step. As a result, time can be saved. Moreover, the precision of the defect coordinates can be improved.

It has been recognized that both an inspection system enabling potential mask defects to be identified and/or localized and a checking system enabling potential mask defects to be checked can be used for pre-classification of the potential mask defects.

The inspection system is also referred to as a first subsystem of the examination system.

The pre-classification system is also referred to as a second subsystem of the examination system.

The checking system is also referred to as a third subsystem of the checking system.

It should be understood here that the subsystems need not necessarily be physically different systems. In particular, it is possible to embody two, in particular at least two, in particular all three, subsystems as a common optical system.

The inspection system and the (sub-)system for pre-classification and/or the (sub-)system for checking can be in particular separate systems. The inspection system and/or the checking system can be embodied together with the pre-classification system as a common system, in particular a single system, in particular as a system having a common radiation source and/or a common illumination optical unit and/or a common projection optical unit.

The subsystem for identifying and/or localizing potential mask defects can be in particular an optical system.

The subsystem for checking potential mask defects can be in particular an optical system.

The subsystem for pre-classification of potential mask defects can be in particular a computing unit and/or an optical system.

The subsystem for pre-classification can have in particular a computing unit and/or an optical system.

In this case, an optical system should be understood to mean in particular a system for examining a mask with the aid of illumination radiation. The optical system can have an illumination optical unit for illuminating the mask with illumination radiation. The optical system can have a projection optical unit for generating an image of the mask. In particular, this can be an aerial image or a digital image. In particular, the optical system can have a plurality of optical elements, in particular in the form of mirrors.

The pre-classification can serve in particular to reduce a list with potential mask defects created during the mask inspection into a pre-classified, shorter list with potential mask defects, which are subsequently checked in the checking step, and/or to comment on potential mask defects in the list with potential mask defects created during the mask inspection. Additional information can be assigned to the defects in the event of comments being given.

In particular, a list of potential mask defects can be created in the inspection step, that is to say by use of the inspection system. This list can be updated in particular after the individual potential mask defects in the list have been analyzed, once again, by use of the pre-classification system.

In particular, in this case “false positive” mask defects can be removed and/or the remaining potential defects can be commented on, wherein the comments can comprise the type and/or the geometric dimensions of the potential mask defect.

As a result, the inspection system can be used particularly efficiently. In particular, a large amount of information about the potential mask defects can be obtained without the subsystem having to be changed. As a result, time and costs can be saved.

Moreover, the running time of the checking system can be reduced since the checking system has to analyze a smaller amount of potential mask defects. In particular, it is even possible to dispense with an analysis of the mask with the checking system.

With the aid of the pre-classification system, it is possible in particular to reduce the number of errors, in particular of so-called “false positives”, which form part of a so-called “nuisance” (disturbance), during the mask inspection, in particular during the identification and/or localization of potential mask defects.

By using a pre-classification system, it is possible in particular to considerably reduce the total time required for checking a mask for EUV lithography.

In the pre-classification of the potential mask defects, the potential mask defects identified and/or localized in the first operating mode can be assessed. In particular, they can be provided with a confidence parameter for characterizing the certainty of the identification and/or for characterizing the relevance of the defect for later applications and/or further additional information.

With the aid of the pre-classification, it is possible in particular to reduce “nuisance”. Nuisance here denotes in particular elements which have been identified as potential defects and which are not of interest to the end customer, in particular do not disturb the latter.

In the pre-classification, it is possible to determine in particular one or more of the following additional information items with respect to a subset of the potential defects, in particular with respect to all of the potential defects:
Is a potential mask defect a true defect or not (so-called “false positive”)?
Classification of the defect type of a potential mask defect and
Measurement of one or more defect parameters, in particular size, shape, coordinates.

The number of potential mask defects to be checked can be considerably reduced by the pre-classification of the potential mask defects. As a result, considerable time and costs can be saved.

In accordance with one aspect, the pre-classification system can be designed in such a way that the number of potential mask defects to be checked in the subsequent checking step proceeding from the potential mask defects identified in the first method step is reduced.

In accordance with one aspect, the pre-classification system can be designed in such a way that the rate of processing the potential mask defects is greater than the rate of checking potential mask defects by use of the checking system. This can result in a time saving.

Rate can be understood here to mean in each case the number of potential mask defects to be pre-classified or to be checked that is processed or checked per unit time.

The pre-classification system can have in particular a rate of processing potential mask defects which is at least double the magnitude, in particular a rate at least three times the magnitude, in particular a rate at least five times the magnitude, in particular a rate at least ten times the magnitude, of the rate of checking potential mask defects by use of the checking system.

In particular, the pre-classification system can be designed in such a way that the time required for recording the images of a potential mask defect in the pre-classification step is shorter than the time required for checking this potential mask defect in the checking step.

This indication can relate to the time required in each case for recording an individual image. It can also relate to the total duration of the time required for the respective method step.

In this context, one or more images of a potential mask defect can be recorded in each case for the pre-classification step and/or in particular for the checking step. In the case of a plurality of images, these can be averaged. By way of example, the image noise can be reduced as a result.

Usually, the rate of pre-classification of potential mask defects can be lower than the rate of identification and/or localization of potential mask defects by use of the inspection system.

Moreover, the proportion of the elements wrongly identified as a potential mask defect that are intended to be checked in the checking step can be reduced with the aid of the pre-classification. While the proportion of the non-disturbing potential mask defects (nuisance) in the inspection step can be up to 99.99%, this proportion can be reduced to at most 90% by the pre-classification.

In accordance with one aspect, the inspection system can be designed in such a way that it can be operated in two different operating modes, wherein, in a first operating mode, it serves for optical inspection of a mask for identifying and/or localizing potential mask defects and, in a second operating mode, it serves for pre-classification of these potential mask defects.

In order to use the inspection system for pre-classification of potential mask defects, this system can have different scanning speeds. This makes it possible to scan the mask at a lower scanning speed for pre-classification of the potential mask defects compared with during the optical inspection of the mask. The ratio of the scanning speed in the first operating mode to the scanning speed in the second operating mode of the inspection system can be in particular at least 2 : 1, in particular at least 3: 1, in particular at least 5: 1.

For pre-classification of the potential mask defects, images of the potential mask defects can be recorded once again, in particular. In particular, the additional images can be recorded using the inspection system with which the potential mask defects were identified and/or localized.

In this case, the images can be recorded with a longer recording duration and/or a higher radiation power and/or a larger numerical aperture than in the inspection step.

The recording duration, in particular the exposure duration, of an image in the pre-classification step can be in particular at least double the magnitude, in particular at least three times the magnitude, in particular at least five times the magnitude, of that in the inspection step.

The radiation power when recording the images in the pre-classification step can be in particular at least double the magnitude, in particular at least three times the magnitude, in particular at least five times the magnitude, of that in the inspection step.

The numerical aperture of the illumination optical unit and/or of the projection optical unit of the pre-classification system used in the pre-classification can be in particular at least 10%, in particular at least 20%, in particular at least 30%, in particular at least 50%, greater than the corresponding values of the inspection system during the inspection of the mask.

The mask to be examined does not need to be removed from the inspection system, in particular for pre-classification.

In accordance with a further aspect, at least two, in particular all three, of the following systems can use a common mask holder: inspection system, pre-classification system and checking system.

The examination system can be designed in particular in such a way that the mask to be examined can remain in the same physical system, in particular need not be transferred between different systems, between the inspection and the pre-classification of the mask defects and/or between the pre-classification and the checking of the mask defects. As a result, the accuracy of the examination of the mask can be improved. Moreover, this can result in a time saving.

In accordance with a further aspect, the checking system can be designed in such a way that it can be operated in two different operating modes, wherein, in a first operating mode, it serves for pre-classification of potential mask defects and, in a second operating mode, it serves for checking potential mask defects.

Checking the potential mask defects should be understood to mean in particular the final assessment thereof, in particular with regard to their relevance for the further use of the mask. The checking is also referred to as verification or review.

For checking the potential mask defects, the checking system can use in particular illumination radiation from the same wavelength range, in particular illumination radiation of the same wavelength, which is also provided for the later use of the mask. In particular, the checking system can be an actinic system. In particular, the checking system can be an EUV system.

In particular, the checking system can be an aerial image measuring system. For details, reference should be made by way of example to DE 10 2010 029 049 A1 and U.S. patent 9,110,225.

In accordance with a further aspect, the pre-classification system can be designed such that it can be operated in at least two, in particular at least three, different operating modes. In this case, it can serve for pre-classification of potential mask defects in one operating mode. It can additionally serve for inspection of a mask for identifying and/or localizing potential mask defects in a further operating mode and/or for checking the potential mask defects in a further operating mode.

The different operating modes of the pre-classification system can differ in particular in terms of one or more of the following parameters:
recording duration for an individual potential mask defect or rate of the recorded or processed mask defects,
exposure duration per image.

The inspection system can have an illumination optical unit for illuminating the mask with illumination radiation and a projection optical unit for generating images of the mask defects.

The checking system can have an illumination optical unit for illuminating the mask with illumination radiation and a projection optical unit for generating images of the mask defects.

In accordance with one aspect, the checking system can at least partially use the illumination optical unit and/or the projection optical unit of the inspection system.

As a result, the overall system for examining the masks can be simplified.

In particular, the checking system and the inspection system can have a single, common illumination optical unit and/or a single, common projection optical unit.

In accordance with one aspect, the inspection system, the pre-classification system and the checking system can be a single optical system which can be operated in three different operating modes.

This system can have one or a plurality of, in particular different, radiation sources for generating illumination radiation.

In accordance with one aspect, the inspection system for optical inspection of the mask can use EUV radiation.

As a result, it is possible to improve the accuracy, in particular in the localization of potential mask defects, and/or the classification accuracy.

In accordance with a further aspect, at least one, in particular at least two, in particular all three, subsystems of the system for examining the mask for EUV lithography can use machine learning.

In particular, it is possible for the inspection system for identifying and/or localizing potential mask defects to use machine learning. Machine learning can be used in particular in the inspection step or for the inspection step.

In particular, it is possible for the pre-classification system for pre-classification of potential mask defects to use an algorithm on the basis of machine learning. Machine learning can be used in particular in the pre-classification step or for the pre-classification step.

In particular, it is possible for the checking system for checking potential mask defects to use machine learning. Machine learning can be used in particular in the checking step or for the checking step.

In this case, the data can be used by the checking system as training data sets.

For details of a detection algorithm for identifying potential mask defects with the aid of machine learning, in particular with the aid of deep learning, reference should be made to WO 2024/160 623 A1 and US 2025/0259293, which are herein incorporated by reference in their entireties.

An autoencoder-based defect detection algorithm is likewise known from WO 2024/160 623 A1.

A further defect detection algorithm is known from DE 10 2023 104 378 A1 and US 2025/0336059, to which references are hereby made. The entire contents of DE 10 2023 104 378 A1 and US 2025/0336059 are incorporated by reference.

Traditional image processing methods known from the prior art can also be used for identifying, classifying or checking potential defects.

In accordance with a further aspect, the pre-classification system can have a selection of different stops. In particular, it can have a selection of different sigma stops in the beam path of the illumination optical unit. The stops can be available in the subsystem or else be specifically developed and introduced into the subsystem in order to optimize the accuracy of the prediction/classification and detection. The pre-classification system can have a selection of a wide variety of NA stops (numerical aperture stops) in particular in the beam path of its projection optical unit.

As a result, the system can be flexibly adapted to different details of a lithography apparatus provided for the later use of the mask, in particular to details of an illumination provided during the later use of the mask. In particular, different properties, for example transmission and/or imaging, can be optimized as a result.

The exposure time of the camera can be reduced by use of a suitable selection of stops.

In accordance with a further aspect, the pre-classification system is designed to generate or provide in each case a reference image with respect to the image of a potential mask defect.

The image of a potential mask defect is also referred to as a defect image.

For generating or providing reference images, the pre-classification system can have a recording device for recording actual images, in particular aerial images, potential mask defects, and/or a computing device for synthetically generating reference images, and/or a database with reference images.

In particular, the computing device for synthetically generating reference images and the database with reference images need not necessarily be physical parts of the pre-classification system; they can also be separate components.

Actual reference images can be recorded by use of a recording device. Systematic influences caused, for example, by fluctuations in the radiation source and/or systematic defects in the illumination optical unit and/or projection optical unit of the respective subsystem can then be eliminated by simple subtraction of the reference image from the image of a possible mask defect.

In principle, time and/or operating costs can be saved by synthetic generation of reference images.

The synthetic generation of reference images, i.e., the simulation of reference images, can be effected in particular in an external computing device. In particular, it can be effected in parallel with the recording of the images of the potential mask defects using the respective subsystem. The generation of a reference image can also be started as soon as a potential defect is detected. The reference image can then already be ready before the mask is checked, in particular before the mask is transferred/loaded into the checking system and measured there. This results in a time saving.

A selection of the following parameters can influence the synthetic generation of the reference images:
Design and/or structure(s) on the mask.
Material of the absorber.
Roughness of the absorber, the ruthenium capping layer or the various multilayers which give rise to the EUV mask reflectivity.
Other properties of the absorber, and also structures: corner rounding, side wall angle, and possible contaminations (oxidation or carbon contamination). - Subsystem 2 properties such as apodization, aberrations, noise signal, system vibrations.
Type and/or construction of the mask.

Providing reference images in a database can further save time. The database can be upgradable. In particular, it can be equipped with actual images that were recorded in the precision mode or by use of the pre-classification system.

In particular, it is possible to use individual actually recorded reference images a number of times, in particular to use them as reference images for different potential mask defects.

In accordance with a further aspect, an external computing device can be used to process the data generated in the precision mode or by use of the pre-classification system.

This makes it possible for the data generated in the precision mode or by the pre-classification system to be processed separately, in particular in parallel. As a result, considerable time can be saved.

In particular, a supercomputer can serve as an external computing device. In particular, computers with different computing nodes adapted on demand are referred to as supercomputers. Nodes can be central processing unit (CPU) and graphics processing unit (GPU), the number of which is specifically adapted to the computing power demand.

In accordance with one aspect, EUV radiation can be used in an inspection step for recording images of a provided mask, on the basis of which potential mask defects (doi) are identified and/or localized. Inspection of the mask using DUV radiation or illumination radiation from a different wavelength range is likewise possible.

Such an image of the masks is also referred to as a mask image. In a subsequent pre-classification step, the images of the potential mask defects are recorded and pre-classified into at least two non-empty subsets. Potential mask defects are checked in a subsequent checking step.

In accordance with one aspect of the invention, the same optical system which is used for carrying out the inspection step and/or the same optical system which is used for carrying out the checking step can be used for carrying out the pre-classification step. In principle, the inspection step, the pre-classification step and the checking step can all be carried out using a single optical system. The number of subsystems, in particular optical systems, provided for carrying out the examination steps, inspection, pre-classification and checking, can in particular be smaller than the number of different examination steps.

With regard to the advantages, reference is made to the description above.

In accordance with a further aspect, the system is used in a different operating mode for carrying out the pre-classification step compared with the operating mode for carrying out the inspection step and for carrying out the checking step.

The system for carrying out the pre-classification step is adapted in particular for carrying out this pre-classification step.

If the inspection system is used as a pre-classification system, the inspection system can have in particular an inspection mode and a further, in particular a more precise, pre-classification mode.

If the checking system is used as a pre-classification system, it can have a faster pre-classification mode in addition to the checking mode.

For the exemplary description of the different operating modes, reference should be made to the following description of exemplary embodiments, which are not to be understood as limiting in this respect, however.

The different operating modes of the exemplary embodiments described below can be combined in particular with further aspects and details of the invention in this case.

In accordance with one aspect, in the pre-classification step, with respect to each potential mask defect identified in the inspection step, at least one image is recorded and at least one reference image is generated or provided.

In this case, the number of images recorded in the pre-classification step can be in particular at most ten times, in particular at most five times, three times, in particular at most twice, in particular at most equal to, the number of potential mask defects identified in the inspection step. The number of images recorded in the pre-classification step can also be less than the number of potential mask defects identified in the inspection step. The number of images recorded in the second inspection step can be in particular at most ten times, in particular at most five times, three times, in particular at most twice, in particular at most equal to, the smallest integer, which is at least equal to the ratio of the size of the mask to the size of the image field of the pre-classification system.

In accordance with a further aspect, for generating or providing the reference images in the pre-classification step, actually a further image can be recorded and/or a reference image can be synthetically generated and/or a reference image can be provided from a database.

In accordance with a further aspect, in the pre-classification step, a maximum of ten images, in particular a maximum of five images, in particular a maximum of three images, in particular a maximum of two images, in particular a maximum of a single image, of a given segment of the mask is recorded in each case.

As a result, the total time expenditure incurred for the pre-classification step can be considerably reduced. The pre-classification step is therefore also referred to as a fast selection method (fast disposition mode).

The recorded images can be averaged in order to reduce noise.

In accordance with a further aspect, a saturation of the camera can be a maximum of 50%, in particular a maximum of 30%, in particular a maximum of 20%, in particular a maximum of 10%, when recording the images of the potential mask defects in the pre-classification step.

As a result, the method can be particularly fast. As has surprisingly been found, possibly increased noise (shot noise; Poisson noise) on account of the low camera saturation and/or the short integration time, in particular a reduced signal-to-noise ratio (SNR), can be accepted.

The integration time can be particularly short, in particular.

In particular, the time required for recording the images of a potential mask defect in the pre-classification step can be shorter than the time required for checking this potential mask defect in the checking step. The ratio can be in particular at most 0.9, in particular at most 0.5, in particular at most 0.1.

This indication can relate to the time required in each case for recording an individual image. It can also relate to the total duration of the time required for recording all images of a potential mask defect in the respective method step.

In this context, one or more images of a potential mask defect can be recorded in each case for the pre-classification step and/or in particular for the checking step. In the case of a plurality of images, these can be averaged. By way of example, the image noise can be reduced as a result.

The maximum time for recording a specific segment of the mask can be in particular at most 2 s, in particular at most 1 s, in particular at most 500 ms, in particular at most 300 ms, in particular at most 200 ms, in particular at most 100 ms.

In accordance with a further aspect, the pre-classification step can comprise algorithmic denoising of the images recorded in the second inspection step.

Fewer photons are then sufficient for recording the images. As a result, the operating costs of the source can be reduced. In addition, time can be saved as a result.

In accordance with a further aspect, all images recorded in the pre-classification step can be recorded with the same focus setting. This can be an optimized focus setting (global best focus plane). For details, reference should be made to DE 10 2014 018 510 A1, the entire content of which is herein incorporated by reference. Refocusing can be dispensed with.

As a result, time can be saved.

Alternatively, the focusing can follow the z-plane generated by the mask alignment.

In accordance with a further aspect, all images recorded in the pre-classification step can be recorded with the same illumination setting. Changing the illumination during the second inspection step can be completely dispensed with. In this case, the illumination setting comprises the shape of the stop and the illumination angle or the illumination angle distribution.

As a result, the pre-classification step can be further simplified, in particular speeded up.

In accordance with a further aspect, images of all potential defects can be recorded in succession in a single pass in the pre-classification step. In particular, it is possible to dispense with processing steps and preparation steps between the individual recordings. The result can be a large file with a multiplicity of images (camera frames).

As a result, the pre-classification step can be further simplified, in particular speeded up.

In accordance with a further aspect, the number of files for pre-classification of the potential mask defects is smaller than the number of potential mask defects.

The number of files for pre-classification of the potential mask defects of a mask to be examined can be in particular at most 72, in particular at most 36, in particular at most 16, in particular at most 8, in particular at most 4, in particular at most 1.

In accordance with a further aspect, in the first inspection step images are recorded which, taken together, cover at least 50%, in particular at least 70%, in particular at least 90%, of the total area to be imaged, in particular the total area to be imaged, of the mask.

In this case, it is possible to take account of the fact that there may be regions on the mask which are not used later for the production of structures. No images of these regions need be recorded. These regions are not part of the total area to be imaged. The total area to be imaged can be in particular 10% to 90% of the total area of the mask.

In accordance with a further aspect, the inspection system can be used for carrying out the pre-classification step, wherein one or more of the following measures are carried out before and/or when carrying out the pre-classification step:
carrying out a mask alignment correction,
carrying out a recalculation of at least one attribute of a potential mask defect,
carrying out a focus offset correction,
re-recording at least one image of at least one of the potential defects,
re-recording at least one reference image.

In particular, it is possible for the mask to be realigned and/or readjusted for an analysis in the pre-classification mode. For this purpose, in particular in the inspection mode, recordings of at least one position marking on the mask can be created, with the aid of which the mask can be realigned and/or readjusted. In particular, the realignment of the mask in the pre-classification mode can be more precise than the preceding alignment of the mask in the inspection mode.

Provision can be made for the focus of the inspection system to be reset for the pre-classification.

The pre-classification mode can also differ from the inspection mode in that the recording duration in the pre-classification mode is greater than in the inspection mode. As a result, the effect of background noise, in particular so-called “shot noise” (Poisson noise), can be reduced, in particular a signal-to-noise ratio (SNR) can be improved.

Alternatively or additionally, a plurality of images can also be recorded in the pre-classification mode. In particular, at least 2, in particular at least 5 and in particular at least 10 images of a potential mask defect can be recorded in each case in the pre-classification mode.

It is possible for a final image to be created from the plurality of images, for example by averaging. The SNR can also be improved in this way.

This analysis of the potential mask defects in the pre-classification step can improve the localization and/or identification of the potential mask defects. In particular, it is possible for so-called “false positive” mask defects (“nuisance”), i.e., mask defects incorrectly identified in the inspection step, or mask defects which are of no significance for the further processing of the mask, to be recognized by the analysis in the pre-classification mode. These mask defects then do not have to be taken into consideration any further. This results in a time saving.

Moreover, the images of potential mask defects recorded in the pre-classification mode of the inspection system can in particular be of higher quality than the images of potential mask defects recorded in the inspection mode. In particular, the images recorded in the pre-classification mode can be recorded in better focus and/or can have a higher signal-to-noise ratio.

It is likewise possible that a type can already be allocated to potential mask defects by use of the analysis of the potential mask defects in the pre-classification step.

It is also possible that a shape and/or a geometric dimension of the potential mask defect can already be determined by use of the analysis of the potential mask defects in the pre-classification step.

Corresponding measures can alternatively or additionally also be carried out before or for carrying out the checking of the potential mask defects in the checking step. In this case, the same or a different combination of measures can be carried out.

In accordance with a further aspect, provision can be made for the inspection system to be used for carrying out the pre-classification step, wherein images of just a subset of the potential mask defects are recorded.

In accordance with a further aspect, the pre-classification system is designed to analyze at least one position marking of the mask. As a result, the at least one position marking can be captured more precisely. In particular, provision can be made for at least one position marking of the mask to be captured and/or analyzed in the pre-classification step.

In particular, a coordinate system for the potential mask defects can be created or updated by use of a more precisely captured position marking. This coordinate system can be used as a basis for the further analysis of the mask, for example, in the pre-classification step and/or in the checking step. It is also possible for this coordinate system to be used in association with mask repair systems, not described in more specific detail here.

In accordance with a further aspect, the pre-classification system can be designed to allocate attributes to the potential mask defects. These attributes can be in particular a brightness, a contrast, a size, a background structure, a background grey level and/or a grey level difference. In particular, provision can be made for such attributes to be assigned in the pre-classification step.

In particular, the allocation can be effected on the basis of one or more images recorded in the inspection mode and/or in the pre-classification mode.

In particular, it is possible for these images to be compared with one or more reference images, which can be loaded from a database, for example.

In accordance with a further aspect, the inspection system is designed to record reference images, in particular of the potential mask defects. The reference images can be recorded in particular in the inspection mode or in the pre-classification mode.

In accordance with a further aspect, the inspection system can have an optimized focus setting in the pre-classification mode. In particular, it is possible to record a focus stack in the pre-classification mode. The best focal position can be ascertained from said focus stack.

The optimum focus setting is dependent in particular on the mask defect under consideration. In particular, it can be determined and set individually for the mask defects.

The optimized focus setting, in particular the optimum focus setting, can be used in each case only for one mask defect from the list of potential mask defects. It is possible that, if more than one mask defect is to be analyzed in the precision mode, the optimum focus setting is adapted between the analysis of the two mask defects.

It is possible to create a focus map for a mask to be examined. In particular, the focus map can have the positions of the potential mask defects. The focus map can have information about the optimum focus setting for individual regions of the focus map.

It is possible that the optimum focus setting for a mask defect is not known. In that case, a focus calibration with the aid of a focus calibration pattern can be used to determine the optimum focus setting.

Alternatively, for focus calibration, it is also possible to record a multiplicity of images with different focus settings, wherein the focus settings of that image exhibiting the best contrast are used as optimum focus settings.

In accordance with a further aspect, images, in particular test images and/or reference images, which have been recorded by the first subsystem in the precision mode can also be used to identify and/or localize the potential mask defects.

In particular, provision can be made for images of only at most 80% of the potential mask defects, in particular at most 50% of the potential mask defects, to be recorded in the pre-classification step.

As a result, the time required for pre-classification of the potential mask defects can be reduced.

In particular, provision can be made for a subset of the potential mask defects to be pre-classified without new images being recorded. In this case, in particular, an algorithm on the basis of machine learning can be used.

In particular, provision can be made for sorting out a subset of the potential mask defects, solely on the basis of assessments of the images recorded in the inspection step, as potential mask effects that do not require further checking, in particular are categorized as definitely true or as erroneous as a defect. The potential mask defects which have been sorted out then need not be checked by use of a checking step.

In accordance with a further aspect, provision can be made for images of at least a subset, in particular all, of the potential mask defects to be recorded in the pre-classification step by use of the inspection system. The inspection system can be used for carrying out the pre-classification step, wherein in particular images of potential mask defects are recorded with a higher quality than in the inspection step.

The images of the potential mask defects recorded in the pre-classification step can have in particular a better signal-to-noise ratio, in particular a signal-to-noise ratio better by at least a factor of 1.5, in particular at least 2, in particular at least 3, in particular at least 5, than the images recorded in the inspection step.

The images of the potential mask defects recorded in the pre-classification step can be recorded in particular with a longer exposure duration and/or with a higher illumination intensity and/or with a larger numerical aperture. A larger number of images of a potential mask defect can also be recorded. In particular, a focus stack of a potential mask defect can be recorded. In this respect, reference should be made to the description above.

In the pre-classification step, it is possible in particular to reduce the number of so-called false positives (nuisance). As a result, it is possible in particular to reduce the time required for the subsequent checking step.

In accordance with a further aspect, provision can be made for EUV radiation to be used for recording an image of the mask in the inspection step.

The use of EUV radiation for optical inspection of the mask for identifying and/or localizing potential mask defects makes it possible to achieve a higher accuracy compared with inspection systems using longer-wave radiation.

In particular, the inspection system can be an actinic system. That should be understood to mean a system which, for inspecting the mask, uses illumination radiation of the same wavelength as is provided during the later use of the mask for generating structures on a wafer.

As an alternative thereto, the inspection system can also use illumination radiation having a different wavelength than that which is provided for the later use of the mask, for example – but not exclusively – 193 nm.

The inspection system can use in particular illumination radiation having a wavelength of 13.5 nm or 7 nm.

In accordance with a further aspect, provision can be made for images of the potential mask defects to be recorded in the pre-classification step by use of the checking system.

In particular, the checking system can be used for carrying out the pre-classification step, wherein the checking system is operated in a so-called fast disposition mode (fast sorting mode).

In the fast disposition mode, the rate at which images of the potential mask defects are recorded is greater than the rate at which potential mask defects are checked in the checking step, in particular greater than the rate at which images of the potential mask defects are recorded in the checking step.

This can be effected individually in particular for a selection, in particular for all, of the potential mask defects.

Individual advantageous aspects of the invention are described once again in supplementary fashion below. These aspects can be combined substantially freely with the aspects described above. The aspects and details described below are not to be understood as limiting, in particular. They are to be understood in particular as a supplementation or as an alternative to the description above.

In accordance with one aspect, provision is made for a multi-stage method and/or a system having a plurality of subsystems to be used for inspecting a lithography mask. In this case, potential mask defects are initially identified and/or localized in particular with the aid of a first subsystem, in particular in the form of an inspection system, or in an inspection mode. The potential mask defects are then pre-classified, in particular assessed with a confidence parameter, in particular with the aid of a pre-classification system and/or a computing unit. In this case, the computing unit can be part of the pre-classification system or can be separate therefrom, and then a subset of the potential mask defects is checked depending on the pre-classification, in particular depending on the confidence parameter, thereof. For example, each of the potential mask defects having a confidence parameter value less than a predetermined threshold value, meaning that the system is unsure whether the potential mask defect is in fact a relevant mask defect, is checked. For this purpose, the inspection system can be used in a checking mode. As an alternative thereto, the potential defects, in particular a selection thereof, can be checked in a separate checking system.

In particular, the checking system can be controllable in such a way that, depending on the confidence parameters assigned to the potential mask defects, just a subset of the mask defects identified and/or localized by the inspection system is checked.

According to the invention, it has been recognized to be advantageous to sort out from the potential mask defects ascertained in the first sub-step those which allow a decision to be made with a predefined reliability as to whether they are in fact relevant mask defects, without requiring further checking. It can likewise be advantageous to sort out those potential mask defects (so-called false positives) which allow a decision to be made with a predefined reliability that they are not defects or are defects that are not relevant to the further use of the mask, without requiring further checking.

In the checking step, it is then only necessary to check a proper subset of the potential mask defects ascertained in the first method step. This subset contains fewer defects than the list of potential mask defects ascertained in the inspection step. This leads to a considerable time saving.

The system and the method are equally suited to inspecting a mask and to inspecting a mask blank. The term mask should be understood to mean both actually structured masks and unstructured masks, i.e., mask blanks.

EUV radiation should be understood to mean electromagnetic radiation at a wavelength ranging from 5 nm to 30 nm. In particular, this can relate to radiation at a wavelength of 13.5 nm or 7 nm.

In accordance with one aspect of the invention, an automated image analysis method, in particular an automated pattern recognition method, is used for pre-classification of the potential mask defects. In particular, this can be a fully automatic method. In particular, this can be a non-algorithmic method.

As a result, the pre-classification can be carried out particularly efficiently. The pre-classification can be carried out particularly quickly, in particular.

The method for pre-classification of the potential mask defects can also have algorithmic pre- or post-treatment steps, in particular filtering steps and/or transformation steps, for example one or more Fourier transforms. In particular, the pre-classification can be carried out on the basis of data in the spatial domain or in the frequency domain.

In accordance with a further aspect, machine learning is used for pre-classification of the potential mask defects. The pre-classification of the potential mask defects can be assisted or effected in particular by a self-learning method, in particular by machine learning. In particular, the subsystem for pre-classification of the potential mask defects can use machine learning. This aspect is in particular independent of the other aspects of the invention. In particular, the pre-classification can be carried out in software-based fashion. In particular, the data relating to the potential mask defects from the inspection step and/or those from the checking step can be used as training data.

The inspection system and/or the pre-classification system and/or the checking system can comprise in particular a data processing device. In particular, the data processing device serves to process the data provided by the inspection system for identifying and/or localizing potential mask defects.

The checking system can be connected to the inspection system in a data-transferring manner. It can also be embodied as part of the inspection system. It can also be embodied as a separate subsystem.

The checking system can comprise a separate optical system. In particular, it can comprise an optical system for imaging the mask. In particular, this can be an actinic system.

In this context, an actinic system should be understood to mean a system which, for imaging and/or checking, uses illumination radiation at a wavelength corresponding to the wavelength that is provided for the subsequent use of the mask in a projection exposure apparatus for structuring a wafer.

In particular, the checking system can comprise an EUV system.

In accordance with a further aspect of the invention, the system for pre-classification of potential mask defects can use the same optical system as the subsystem for checking the mask. The two subsystems for pre-classification and for checking potential mask defects can have in particular a common optical system. This reduces the constructional outlay for the overall system.

The two subsystems for pre-classification and for checking potential mask defects can be formed in particular by a common optical system, in particular an identical optical system, which is used in different operating modes.

The two subsystems for pre-classification and for checking potential mask defects can also each have independent optical systems. This enables the pre-classification step and the checking step to be carried out in parallel. This can increase the overall throughput of the system.

In accordance with a further aspect of the invention, the system for identifying and/or localizing potential mask defects and/or the system for checking potential mask defects have/has a memory for storing a database with pre-classified mask defects. In particular, the inspection system and/or the checking system can have a memory with a database with pre-classified mask defects. The database can also be interchangeable. In particular, the database can be updatable and/or upgradable.

In particular, it is possible to compare the potential mask defects identified and/or localized by the inspection system with pre-classified mask defects from the database. It has been found that this facilitates a fast yet reliable classification of mask defects. This aspect is independent of further details of the invention.

In particular, the database can be upgradable. This improves the predictability of the classification of the mask defects.

The database can also be interchangeable. This makes it possible to keep available specific databases for different mask types, for example, for masks with different structure elements. This can further improve the reliability of the pre-classification.

In accordance with a further aspect of the invention, the potential mask defects can be categorized into at least two classes, in particular into two, three or more classes, by use of the pre-classification.

In this context, one class contains the mask defects that do not require further checking. A class separate therefrom contains the mask defects that ought to be checked.

In particular, the certainly incorrectly identified defects (so-called false positives; nuisance/disturbance), in particular the elements which are identified as potential defects and which are certainly not relevant to the end customer, are classified in the class with the mask defects that do not require further checking. Such an erroneous identification of a potential defect may be attributable, for example, to sensor noise or to the detected element being so small that it can be classified as non-relevant with certainty.

The remaining defects, which do not allow a statement, in particular about their relevance to the end customer, to be made with sufficient certainty are classified into a further class.

The assignment of the potential defects to the different classes can be determined on the basis of one or more parameters. These can be continuous or discrete parameters.

It has been found that it is usually possible to considerably reduce the number of mask defects to be checked in the checking step by way of the pre-classification carried out with the aid of the pre-classification system.

The ratio of the number of mask defects to be checked to the total number of mask defects identified and/or localized by use of the inspection system or in the inspection step is in particular at most 20%, in particular at most 10%, in particular at most 5%, in particular at most 3%, in particular at most 2%, in particular at most 1%.

In accordance with a further aspect of the invention, the classification speed v₂ is greater than the checking speed v₃, v₂ > v₃. In this context, speed should be understood to mean in each case the rate of capture, analysis or processing of potential mask defects. The speed can be measured in particular as a number of defects per unit time.

The classification speed v₂ is in particular at least 500 classified defects per hour, in particular at least 750 classified defects per hour, in particular at least 1000 classified defects per hour, in particular at least 1250 classified defects per hour, in particular at least 1500 classified defects per hour, in particular at least 2000 classified defects per hour.

In particular, the following applies: v₂/v₃ > 1.1, in particular v₂/v₃ > 1.2, in particular v₂/v₃ > 1.5, in particular v₂/v₃ > 2, in particular v₂/v₃ > 2.5, in particular v₂/v₃ > 3, in particular v₂/v₃ > 5, in particular v₂/v₃ > 10. In particular, the following applies: v₂/v₃ > 1/(1-a), where a specifies the expected ratio of the number of potential mask defects to be checked to the number of potential mask defects to be classified. The number of potential mask defects to be classified in this context corresponds precisely to the number of potential mask defects identified and/or localized. The ratio a can be determined experimentally on the basis of masks to be checked.

In accordance with a further aspect of the invention, the inspection system for inspection of the mask can use illumination radiation at a wavelength of more than 30 nm, in particular more than 100 nm. In particular, the first subsystem can comprise a non-actinic optical system. In particular, it can comprise a DUV system. In this respect, reference should be made by way of example to US 8,103,086 B2.

In particular, the inspection system can use illumination radiation at a wavelength of 193 nm or more for the inspection of the mask.

The inspection system can also use illumination radiation having a wavelength in the EUV range, in particular of 13.5 nm or 7 nm.

In accordance with a further aspect of the invention, the system for pre-classification of the potential mask defects and/or the system for checking a subset of the potential mask defects have/has an optical system with illumination radiation at a wavelength in the EUV range.

The corresponding subsystem can have in particular an actinic optical system, in particular can be embodied as an actinic system.

The subsystem for pre-classification of the potential mask defects and/or the subsystem for checking a subset of the potential mask defects can have in particular an actinic aerial image system, that is to say an optical system with illumination radiation at a wavelength in the EUV range for generating an aerial image of the mask. In particular, this can be a scanning system. In respect of an actinic aerial image system, reference should be made by way of example to DE 10 2010 029 049 A1.

In accordance with a further aspect of the invention, the examination system comprises a storage unit connected to the inspection system and/or to the pre-classification system and/or to the checking system in a data-transferring manner. In particular, the storage unit serves to store a data record with data relating to potential mask defects.

In particular, the storage unit can have been connected or can be connected to the checking system in a data-transferring manner.

The data in relation to potential mask defects ascertained by the inspection system and/or pre-classification system can be stored in particular on a physical storage medium or in a virtual memory. In this context, a virtual memory can facilitate the data transfer, in particular from the inspection system, to the checking system.

The data of the ascertained pre-classification of the potential mask defects can be stored on a physical storage medium or in a virtual memory. In this context, storage in a virtual memory facilitates the data transfer to a further subsystem, in particular a separate subsystem.

In accordance with a further aspect of the invention, the pre-classification step comprises an automated image analysis method for pre-classifying the potential mask defects.

The image analysis method can comprise pre-processing steps, for example, filter steps or transformation steps, in particular one or more Fourier transforms.

The image analysis can be carried out in the spatial domain or in the frequency domain.

In accordance with one aspect of the invention, the pre-classification step for pre-classifying the potential mask defects comprises a method on the basis of machine learning. In particular, this can be a method on the basis of supervised learning. This can also relate to reinforcement learning. In this context, the results from the checking step can be utilized for further training of the pre-classification step. In this context, different types of masks, in particular, can be treated separately. This can lead to an improvement in the reliability of the pre-classification.

In accordance with a further aspect of the invention, a distribution of one-dimensional and/or two-dimensional structures from the image of the mask recorded in the first inspection step is analyzed for the purpose of pre-classifying the potential mask defects.

These structures can be analyzed either in the spatial domain or in the frequency domain.

In particular, the one-dimensional structures can be critical dimensions (CDs). In particular, the two-dimensional structures can be contours of the images of the mask recorded in the first inspection step or a Fourier transform of the same. It is also possible to analyze properties of these structures, for example, the diameter thereof.

In accordance with a further aspect of the invention, an intensity distribution of an image of the mask recorded in the first inspection step is analyzed for the purpose of pre-classifying the potential mask defects. In particular, the image of the mask can be analyzed pixel-by-pixel. Upsampling or downsampling is possible.

One or more of the subsystems of the examination system can be imaging systems, which each record an overall image of the mask or of the mask blank or of a partial region thereof in one exposure, or scanning systems, in which the images of the mask or of the mask blank are captured in a scanning fashion and are merged in particular from a plurality of exposures.

In accordance with a further aspect of the invention, the pre-classification step comprises one or more pre-processing steps, in particular one or more correction steps for correcting one or more images recorded in the first inspection step in respect of photon noise.

In accordance with a further aspect of the invention, the pre-classification step comprises a comparison step for comparing one or more images of the mask recorded in the inspection step with data from a database.

In accordance with a further aspect of the invention, the checking step comprises an actinic method, in particular a method for ascertaining and/or analyzing an aerial image, in particular using illumination radiation in the EUV range.

In accordance with a further aspect of the invention, the inspection step can comprise a non-actinic method. In particular, the first inspection step can comprise a method for ascertaining an image of the mask using illumination radiation in the DUV wavelength range, in particular using illumination radiation at a wavelength of 193 nm.

In particular, the method according to the invention can comprise at least two optical inspection steps, in which images of the mask are ascertained and/or analyzed using illumination radiation at different wavelengths. It has been found that this firstly can reduce the time required to inspect the mask and secondly can improve the reliability of the characterization of the mask defects.

In particular, optical systems are provided for identifying and/or localizing the potential mask defects and for checking the latter or a selection thereof.

In accordance with one aspect, the identification/localization and the checking of the potential mask defects can be carried out with the aid of the same optical system, that is to say a single optical system. For this purpose, this optical system can be operated in different operating modes, in particular an inspection mode and a checking mode.

The pre-classification can be a method step which can be carried out independently of an optical system, in particular in a computing unit or an analysis unit. The pre-classification of the potential mask defects can take place in particular offline. It can take place in particular in parallel with optical method steps. As a result, time can be saved.

### BRIEF DESCRIPTION OF DRAWINGS

Further advantages, details and particulars of the invention will become apparent from the description of exemplary embodiments with reference to the figures, in which:

FIG. 1 schematically shows a sequence of a method for examining a mask for EUV lithography,

FIG. 2 schematically shows constituent parts of a system for examining a mask for EUV lithography,

FIG. 3 schematically shows a further illustration of a sequence of a method for examining a mask for EUV lithography, and

FIG. 4 schematically shows an illustration of a possible sequence of recording images in the pre-classification step.

### DETAILED DESCRIPTION

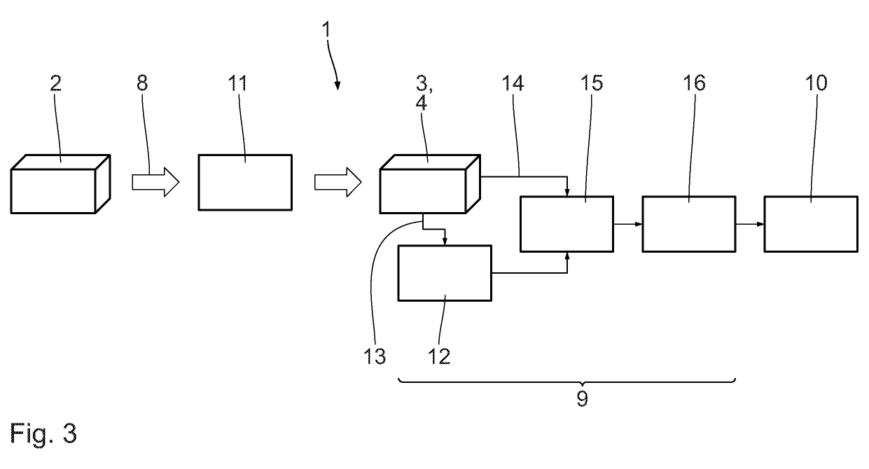

FIG. 2 schematically illustrates a system 1 for examining a mask for extreme ultraviolet (EUV) lithography. The illustration should be understood to be by way of example.

The system 1 comprises an inspection system 2, a pre-classification system 3 and a checking system 4.

Preferably, so-called multilayer defects of the mask, in particular of the mask blank, are ascertained separately with the aid of a separate system, in particular an actinic inspection system (actinic blank inspection tool, ABI tool).

The inspection system 2 serves for optical inspection of the mask. In particular, it serves for identifying and/or localizing potential mask defects.

The inspection system 2 comprises in particular an inspection system for inspecting the mask using illumination radiation in the EUV range, in particular using illumination radiation at a wavelength of 13.5 nm or 7 nm. In particular, this can be an actinic system.

The inspection system 2 can also comprise an inspection system for inspecting the mask using illumination radiation in the deep ultraviolet (DUV) range, in particular using illumination radiation at a wavelength of 193 nm. For details of such a system, reference should be made by way of example and in representative fashion to US 8,103,086 B2, WO 2021 204 541 A1, and US 2023/0020107, which are hereby incorporated by reference in the present application as part thereof.

The pre-classification system 3 serves in particular for pre-classification of the potential mask defects identified and/or localized by use of the inspection system 2.

The pre-classification system 3 can have an optical system having a wavelength in the EUV range, in particular having a wavelength of 13.5 nm or 7 nm.

In particular, the checking system 4 serves for checking the potential mask defects.

The checking system 4 comprises in particular an optical system for checking the mask using a wavelength in the EUV range. For details of such a system, reference should be made by way of example and in representative fashion to DE 10 2010 029 049 A1 and U.S. patent 9,110,225, which are hereby fully incorporated by reference in the present application as part thereof.

As is illustrated schematically in FIG. 2, the inspection system 2 is connected to a first storage unit 5 in a data-transferring manner. The first storage unit 5, in turn, is connected to the pre-classification system 3 in a data-transferring manner.

The first storage unit 5 can be embodied as a separate storage unit, in particular as a separate storage medium, or as a virtual memory. It can also be embodied as a constituent part of the inspection system 2 or as a constituent part of the pre-classification system 3.

The first storage unit 5 serves to store the data ascertained by the inspection system 2 for identifying and/or localizing potential mask defects. The corresponding data serve as input for the further inspection of the mask with the aid of the pre-classification system 3.

The pre-classification system 3 is connected to a second storage unit 6 in a data-transferring manner.

The second storage unit 6 can be embodied as a separate storage unit, in particular as a separate storage medium, or as a virtual memory. It can also be embodied as a constituent part of the pre-classification system 3 or as a constituent part of the checking system 4.

The pre-classification system 3 can have an optical system for examining the mask, in particular for generating and analyzing an aerial image of the mask. In particular, this can be an EUV system.

The inspection system 2 and the pre-classification system 3 can be embodied as a single system.

The checking system 4 comprises an optical system for checking and analyzing potential mask defects. In particular, the optical system of the checking system 4 is an actinic system.

The pre-classification system 3 and the checking system 4 can be embodied as a single system.

In particular, it is possible for all three subsystems, that is to say the inspection system 2, the pre-classification system 3 and the checking system 4, to be embodied as a single system 1. The system 1 can be operated in particular in different operating modes, in particular in an inspection mode, in a pre-classification mode and in a checking mode.

The pre-classification system 3 comprises a memory 7 for storing a database with pre-classified mask defects. The memory 7 can be embodied separately from the pre-classification system 3.

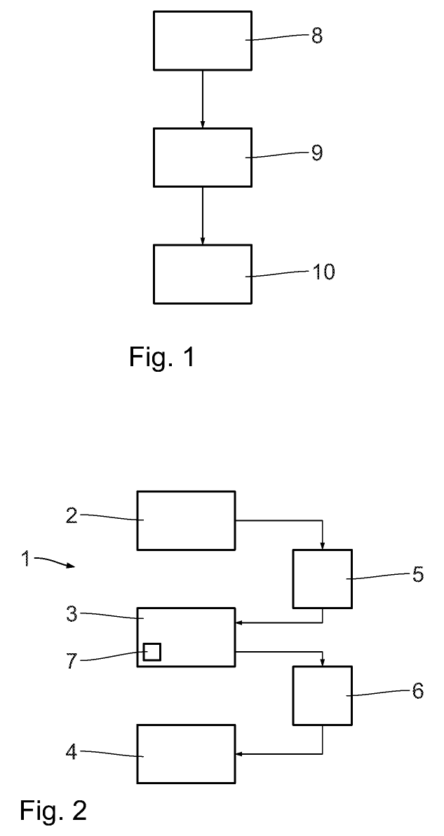

The basic sequence of the method for inspecting the mask is described below with reference to FIG. 1. The method is a multi-stage method. The method comprises in particular a first examination step, in particular an inspection step 8, a second examination step, in particular a pre-examination step 9, and a third examination step, in particular a checking step 10.

The examination steps 8, 9, 10 can in turn comprise one or more substeps.

The inspection step 8 serves in particular for recording an image of the provided mask and for identifying and/or localizing potential mask defects in the provided mask. In particular, images of the entire mask surface to be imaged can be recorded in the inspection step 8. It is also possible to record only images of a partial region of the mask.

The pre-classification step 9 serves in particular for pre-classifying the potential mask defects.

The checking step 10 serves in particular for checking a subset of the potential mask defects.

In the inspection step 8, a structured lithography mask, in particular, is analyzed with the aid of an optical system. In the inspection step 8, a list of potential mask defects is created in particular with the aid of an EUV or a DUV system. The list of potential mask defects can be stored in the first storage unit 5.

In the pre-classification step 9, the mask can be examined using an actinic optical system, in particular an EUV system. In this context, the potential defects as per the list created in the inspection step 8, in particular, are pre-classified.

In particular, provision is made for the potential defects ascertained in the inspection step 8 to be divided into at least two classes, wherein at least one class contains exclusively potential defects that do not need further checking, while at least one other class contains potential defects for which a final assessment as to whether this is in fact a defect, in particular a defect relevant to the envisaged use of the mask, cannot be made with sufficient certainty.

What are classified into one class are in particular potential defects that have a sufficient probability of not being actual defects (so-called false positives), in particular with a confidence of at least 95%, in particular at least 97%, in particular at least 99%.

Moreover, what are classified into one class are potential defects which are true defects, in particular defects relevant to the envisaged use of the mask, with a confidence of at least 95%, in particular at least 97%, in particular at least 99%.

The remaining potential defects, which do not allow a final statement with sufficient certainty, in particular not with a confidence of at least 95%, in particular at least 97%, in particular at least 99%, can be classified into a separate class.

The pre-classification step 9 comprises in particular a fast disposition of the potential mask defects. The classification speed is at least 500 classified defects per hour, in particular at least 750 classified defects per hour, in particular at least 1000 classified defects per hour, in particular at least 1250 classified defects per hour, in particular at least 1500 classified defects per hour, in particular at least 2000 classified defects per hour.

In particular, a method on the basis of machine learning can be used for pre-classification of the potential mask defects in the pre-classification step 9.

Different details and aspects of the method steps for identifying and/or localizing and for pre-classifying the potential mask defects are described below.

The inspection system 2 and/or the pre-classification system 3 can have a fast measurement mode (“fast disposition mode”). In this operating mode, images can be recorded particularly quickly in regard to potential mask defects identified in the inspection step. In this context, it is possible to dispense with the accuracy, in particular resolution, required for the accurate, optical analysis of potential defects. It may be sufficient if the images of the potential defects can be delimited from photon noise with sufficient certainty.

The pre-classification step 9 can comprise pattern recognition. The pattern recognition can comprise a threshold method (threshold setting) and an image contour analysis.

One-dimensional structures and/or two-dimensional and/or logical structures can be analyzed during the image contour analysis. In this context, logical structures should be understood to mean non-symmetrical or non-periodic structures, in particular.

In particular, provision can be made to set an automated threshold in order to measure a critical dimension (CD) for each structure element in the overall image of the mask. It has been found that the analysis of the distribution of the values of the critical dimensions have clearly defined peaks in the frequency domain. Deviations from these peaks can indicate potential defects. It has been found that the power spectral density (PSD) of the critical dimensions in the aerial image has a continuum and peaks, wherein the properties of the peaks can be influenced by defects.

Further, provision can be made for analyzing properties of these peaks, for example, the full width at half maximum (FWHM) thereof. In this context, photon noise can be taken into account.

Training of the system for machine learning for pre-classification of the potential mask defects can be provided in the spatial domain or in the frequency domain.

In addition, provision can be made for carrying out a correction method for correcting photon noise, in particular denoising, in particular algorithmic denoising, before the image analysis in the pre-classification step 9.

In accordance with one variant, provision can be made for variations of the image contours or of a frequency distribution of measured structure parameters of the possibly pre-processed image, in particular noise-corrected image, to be analyzed and to be compared with data in a database of defect-free structures and defects.

In particular, the pre-classification step 9 can comprise a comparison step for comparing potential defects, in particular specific parameters of potential defects, with the corresponding data in a database.

The pre-classification can be effected on the basis of a distribution of ascertained critical dimensions or a distribution of specific parameters of contours in the spatial domain or in the frequency domain. By way of example, low-intensity peaks in the power spectral density (PSD) can indicate defects. A pre-classification on this basis is possible after appropriate preceding training.

As an alternative to a pre-classification on the basis of critical dimensions or contours, provision can also be made for the intensity distribution or the frequency of changes of this distribution to be evaluated. In particular, the evaluation can be carried out pixel-by-pixel. Upsampling or downsampling is also possible. Once again, provision can be made in this context for a correction for taking account of photon noise. The distribution analyzed in this way can be compared with data in a database which was used to train the system for a machine learning method. In this respect, it should be noted that, in particular on account of their contours, defects have different frequencies than the usual mask structures, in particular different frequencies than the frequencies of regular mask structures, in particular periodic mask structures.

Further processing steps, for example, smoothing methods (image smoothing) or low-pass filtering steps, can be provided in all of the methods, in particular in order to filter out noise.

In accordance with a further alternative, provision can be made for the images of the mask ascertained in the pre-classification step 9, in particular images of the mask defects, to be compared directly with images in a database.

The database can be constantly supplemented in all of the methods. As a result, it is possible for the pre-classification in the pre-classification step 9 to be constantly improved, in particular made more reliable. This leads as a result to a decrease on average in the ratio of the potential mask defects to be checked in the checking step 10 to the number of potential mask defects ascertained overall in the inspection step 8.

It has been found that, with the aid of the pre-classification in the pre-classification step 9, it is possible to reduce the number of potential mask defects to be checked in the checking step 10 from several thousand potential mask defects ascertained in the inspection step 8 to less than 200, in particular less than 100. If the number of remaining potential mask defects to be checked in principle after the pre-classification step 9 is at most equal to a predefined limit value, provision can be made for dispensing with the checking step 10. This means that the mask then does not need to be loaded into the checking system.

The limit value can be for example ten, five, three, two, one or zero potential mask defects.

An actinic method, in particular an actinic aerial image method, is provided for checking the potential mask defects in the checking step 10.

The overall result of the examination method, in particular of the three examination steps 8, 9 and 10, is a statement regarding the relevance of the mask defects for the envisaged uses of the mask. In particular, whether or not the mask satisfies specific predefined quality criteria can be decided on the basis of this overall result.

In FIG. 3, the constituent parts of the system 1 and different examination steps 8, 9, 10 are schematically illustrated once again in a different way. In principle, reference is made to the description above regarding the subsystems 2, 3 and 4 and regarding the examination steps 8, 9 and 10.

A list 11 of potential mask defects is created by use of the inspection system 2, in particular in the inspection step 8. A file with this list 11 is transferred together with the mask to the pre-classification system 3.

The pre-classification system 3 can have a computing unit for the synthetic generation 13 of reference data, in particular reference images 12.

The reference images can also actually be recorded by use of a recording step 14.

The synthetic generation 13 of the reference images 12 can take place offline.

As a result of processing the images of potential mask defects recorded by use of the pre-classification system 3 with associated reference images, the potential mask defects can be detected in a detection step 15. They can thereupon be pre-classified in a classification step 16.

A selection of the pre-classified potential mask defects can be checked in the checking step 10.

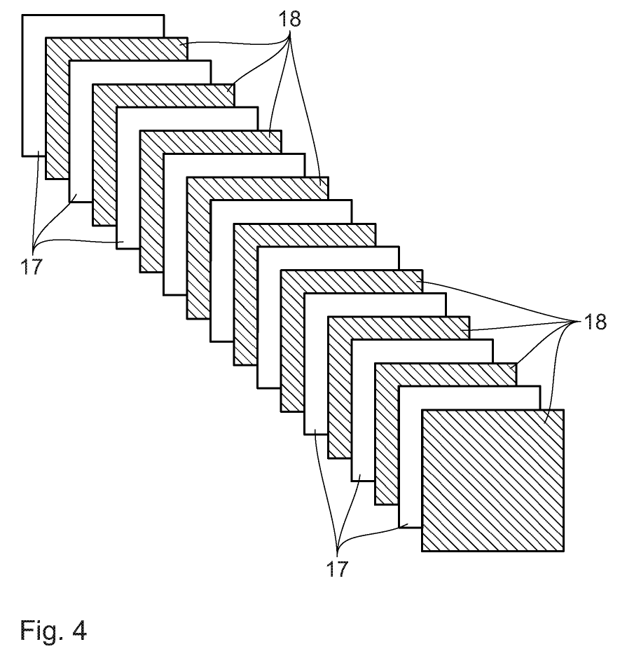

FIG. 4 schematically illustrates a possible sequence of recording images 17 of potential mask defects. The sequence relates in particular to the pre-classification step. In this case, provision can be made for a so-called dark frame 18 to be recorded between the recording of each two successive images 17.

It is not absolutely necessary to provide for actually recording a dark frame 18. It is also possible for just the read-out time of a CCD camera or of some other camera to intervene between the recording of two successive images 17.

Provision can also be made for dark frames 18 to be recorded between some of the images 17, but not between all of them. In particular, one, two, three or more dark frames can be recorded. The number of dark frames 18 is preferably at most equal to the number of images 17.

During the recording of the dark frame 18, it is possible to change the relative position of the mask in the pre-classification system 3. Consequently, images of all potential mask defects can be recorded in succession. These can be stored as a stack in a large file.

In principle, it is also possible to record two, three or more images of given potential mask defects, in particular of a selection of potential mask defects, in particular of all of the potential mask defects, in order to reduce the photon noise and in particular to improve the signal-to-noise ratio (SNR). These images can subsequently be averaged.

According to the invention, however, it has been recognized that a reduced signal-to-noise ratio in return for a faster recording, in particular a reduction of the total time required for recording images of all potential mask defects, can be advantageous.

The noise can optionally be reduced by a denoising method, in particular an algorithmic denoising method.

The different images 17 illustrated schematically in FIG. 4 can each correspond to different mask positions, in particular different potential mask defects.

The total recording time required can be reduced in particular by virtue of no processing steps being provided between the recording of the individual images 17. In particular, the image processing can take place completely offline.

In summary, it should once again be stated that two separate method steps are provided for identifying and/or localizing potential mask defects and for checking them. In this case, the different method steps can be carried out in physically separate subsystems. As an alternative thereto, it is possible to carry out the different method steps, in particular the inspection step and the checking step, using one and the same system, which can be used for carrying out the different steps in different operating modes.

Before potential mask defects are checked, they can be pre-classified in a pre-classification step. As a result, a large number of the wrongly identified potential mask defects (“false positives”) can be sorted out. The pre-classification of potential mask defects can be carried out in particular by use of the inspection system and/or by means of the checking system.

It has been found that the total time required for checking a mask can be considerably reduced as a result.

In some implementations, at least one of the inspection system 2, the pre-classification system 3, or the checking system 4 can include a computing unit, which can include one or more data processing devices. Each of the data processing devices can include one or more processor cores, and each processor core can include logic circuitry for processing data. For example, a processor can include an arithmetic and logic unit (ALU), a control unit, and various registers. Each processor can include cache memory. Each processor can include a system-on-chip (SoC) that includes multiple processor cores, random access memory, graphics processing units, one or more controllers, and one or more communication modules. Each processor can include millions or billions of transistors.

In some implementations, the one or more processing devices can include one or more computers, each computer can include one or more data processors for processing data. The one or more machine-readable hardware storage devices can store one or more computer programs including instructions that when executed by the one or more computers cause the one or more computers to carry out the processes described above. The one or more processing devices can include one or more input devices, such as a keyboard, a mouse, a touchpad, and/or a voice command input module, and one or more output devices, such as a display, and/or an audio speaker.

In some implementations, the one or more processing devices can include digital electronic circuitry, computer hardware, firmware, software, or any combination of the above. The features related to processing of data can be implemented in a computer program product tangibly embodied in an information carrier, e.g., in a machine-readable storage device, for execution by a programmable processor; and method steps can be performed by a programmable processor executing a program of instructions to perform functions of the described implementations. Alternatively or in addition, the program instructions can be encoded on a propagated signal that is an artificially generated signal, e.g., a machine-generated electrical, optical, or electromagnetic signal, that is generated to encode information for transmission to suitable receiver apparatus for execution by a programmable processor.

A computer program can be written in any form of programming language, including compiled or interpreted languages, and it can be deployed in any form, including as a stand-alone program or as a module, component, subroutine, or other unit suitable for use in a computing environment.

For example, the one or more computers can be configured to be suitable for the execution of a computer program and can include, by way of example, both general and special purpose microprocessors, and any one or more processors of any kind of digital computer. Generally, a processor will receive instructions and data from a read-only storage area or a random access storage area or both. Elements of a computer system include one or more processors for executing instructions and one or more storage area devices for storing instructions and data. Generally, a computer system will also include, or be operatively coupled to receive data from, or transfer data to, or both, one or more machine-readable storage media, such as hard drives, magnetic disks, solid state drives, magneto-optical disks, or optical disks. Machine-readable storage media suitable for embodying computer program instructions and data include various forms of non-volatile storage area, including by way of example, semiconductor storage devices, e.g., EPROM, EEPROM, flash storage devices, and solid state drives; magnetic disks, e.g., internal hard disks or removable disks; magneto-optical disks; and CD-ROM, DVD-ROM, and/or Blu-ray discs.

In some implementations, the processes described above can be implemented using software for execution on one or more mobile computing devices, one or more local computing devices, and/or one or more remote computing devices (which can be, e.g., cloud computing devices). For instance, the software forms procedures in one or more computer programs that execute on one or more programmed or programmable computer systems, either in the mobile computing devices, local computing devices, or remote computing systems (which may be of various architectures such as distributed, client/server, grid, or cloud), each including at least one processor, at least one data storage system (including volatile and non-volatile memory and/or storage elements), at least one wired or wireless input device or port, and at least one wired or wireless output device or port.

In some implementations, the software may be provided on a medium, such as CD-ROM, DVD-ROM, Blu-ray disc, a solid state drive, or a hard drive, readable by a general or special purpose programmable computer or delivered (encoded in a propagated signal) over a network to the computer where it is executed. The functions can be performed on a special purpose computer, or using special-purpose hardware, such as coprocessors. The software can be implemented in a distributed manner in which different parts of the computation specified by the software are performed by different computers. Each such computer program is preferably stored on or downloaded to a storage media or device (e.g., solid state memory or media, or magnetic or optical media) readable by a general or special purpose programmable computer, for configuring and operating the computer when the storage media or device is read by the computer system to perform the procedures described herein. The inventive system can also be considered to be implemented as a computer-readable storage medium, configured with a computer program, where the storage medium so configured causes a computer system to operate in a specific and predefined manner to perform the functions described herein.

While some embodiments, examples or aspects described herein include some but not other features included in other embodiments, examples or aspects combinations of features of different embodiments, examples or aspects are meant to be within the scope of the claims, and form different embodiments, as would be understood by those skilled in the art.

Accordingly, other embodiments are within the scope of the following claims.

What is claimed is:

1. A method for inspecting a mask for EUV lithography, comprising the following steps:
1.1. providing a mask for EUV lithography,
1.2. providing a system for examining a mask for EUV lithography, having
1.2.1 an inspection system for optical inspection of a mask for identifying and/or localizing potential mask defects,
1.2.2 a pre-classification system for pre-classification of the potential mask defects on the basis of images thereof, and
1.2.3. a checking system for checking potential mask defects,
1.3. an inspection step for recording a mask image of the provided mask and for identifying and/or localizing potential mask defects in the provided mask,
1.4. a pre-classification step for pre-classifying the potential mask defects into at least two non-empty subsets and
1.5. a checking system for checking the potential mask defects,
1.6. wherein the same inspection system which is used for carrying out the inspection step is used as the pre-classification system for carrying out the pre-classification step,
1.6.1 wherein the pre-classification system is used in a different operating mode for carrying out the pre-classification step compared with the operating mode for carrying out the inspection step,
and
1.7. wherein the same checking system which is used for carrying out the checking step is used as the pre-classification system for carrying out the pre-classification step,
1.7.1 wherein the pre-classification system is used in a different operating mode for carrying out the pre-classification step compared with the operating mode for carrying out the checking step.

2. The method according to claim 1, wherein the inspection system is used for carrying out the pre-classification step, wherein one or more of the following measures are carried out before carrying out the pre-classification step:
2.1. carrying out a mask alignment correction,
2.2. carrying out a focus offset correction,
2.3. re-recording at least one image of at least one of the potential defects,
2.4. re-recording at least one reference image,
2.5. carrying out a recalculation of at least one attribute of a potential mask defect.

3. The method according to claim 1, wherein the inspection system is used for carrying out the pre-classification step, wherein images of just a subset of the potential mask defects are recorded.

4. The method according to claim 1, wherein the inspection system is used for carrying out the pre-classification step, wherein images of potential mask defects are recorded with a higher quality than in the inspection step.

5. The method according to claim 1, wherein the checking system is used for carrying out the pre-classification step, wherein the time required for recording the images of a potential mask defect in the pre-classification step is shorter than the time required for checking this potential mask defect in the checking step.

6. A system for examining a mask for EUV lithography, having
6.1. an inspection system for optical inspection of a mask for identifying and/or localizing potential mask defects,
6.2. a checking system for checking potential mask defects and
6.3. a pre-classification system for pre-classification of the potential mask defects on the basis of images thereof,
6.4. wherein the inspection system or the checking system serves as the pre-classification system,
6.5. wherein the inspection system is designed in such a way that it can be operated in two different operating modes, wherein, in a first operating mode, it serves for optical inspection of a mask for identifying and/or localizing potential mask defects and wherein, in a second operating mode, it serves for pre-classification of these potential mask defects, and/or
6.6. wherein the checking system is designed in such a way that it can be operated in two different operating modes, wherein, in a first operating mode, it serves for pre-classification of potential mask defects and wherein, in a second operating mode, it serves for checking potential mask defects.

7. The system according to claim 6, wherein the pre-classification system is designed in such a way that the rate of processing the potential mask defects is greater than the rate of checking potential mask defects by use of the checking system.

8. The system according to claim 6, wherein the inspection system and the checking system each have an illumination optical unit for illuminating the mask with illumination radiation and a projection optical unit for generating images of the mask defects, wherein the checking system at least partially uses the illumination optical unit and/or the projection optical unit of the inspection system.

9. The system according to claim 6, wherein at least two of the following systems, inspection system, pre-classification system and checking system, use a common mask holder.

10. The system according to claim 6, wherein the pre-classification system for pre-classification of potential mask defects uses an algorithm on the basis of machine learning.

11. The system according to claim 6, wherein the pre-classification system has an illumination optical unit having a selection of different σ stops and/or the projection optical unit has a selection of different NA stops.

12. The system according to claim 6, wherein the pre-classification system is designed to generate or provide in each case a reference image with respect to an image of a potential mask defect, wherein the pre-classification system has a selection from the following devices for providing or generating reference images:
12.1. a recording device for recording actual (aerial) images of potential mask defects,
12.2. a computing device for synthetically generating reference images,
12.3. a database with reference images.

13. The method according to claim 2, wherein the inspection system is used for carrying out the pre-classification step, wherein images of just a subset of the potential mask defects are recorded.

14. The method according to claim 2, wherein the inspection system is used for carrying out the pre-classification step, wherein images of potential mask defects are recorded with a higher quality than in the inspection step.

15. The method according to claim 2, wherein the checking system is used for carrying out the pre-classification step, wherein the time required for recording the images of a potential mask defect in the pre-classification step is shorter than the time required for checking this potential mask defect in the checking step.

16. The system according to claim 7, wherein the inspection system and the checking system each have an illumination optical unit for illuminating the mask with illumination radiation and a projection optical unit for generating images of the mask defects, wherein the checking system at least partially uses the illumination optical unit and/or the projection optical unit of the inspection system.

17. The system according to claim 7, wherein at least two of the following systems, inspection system, pre-classification system and checking system, use a common mask holder.

18. The system according to claim 7, wherein the pre-classification system for pre-classification of potential mask defects uses an algorithm on the basis of machine learning.

19. The system according to claim 7, wherein the pre-classification system has an illumination optical unit having a selection of different σ stops and/or the projection optical unit has a selection of different NA stops.

20. The system according to claim 7, wherein the pre-classification system is designed to generate or provide in each case a reference image with respect to an image of a potential mask defect, wherein the pre-classification system comprises at least one of the following devices for providing or generating reference images:
2012.1. a recording device for recording actual aerial images of potential mask defects,
2012.2. a computing device for synthetically generating reference images, or
2012.3. a database with reference images.
